(19) United States
(12) Patent Application Publication
(10) Pub. No.: US 2025/0179285 A1
(43) Pub. Date: Jun. 5, 2025

(54) TERMINALLY UNSATURATED (METH)ACRYLATE CROSSLINKERS AND USE THEREOF

(71) Applicant: Röhm GmbH, Darmstadt (DE)

(72) Inventors: Patrik Hartmann, Buettelborn (DE); Steffen Krill, Muehltal (DE); Bruno Keller, Wackernheim (DE); Christian Maul, Neustadt a. d. W. (DE)

(73) Assignee: Röhm GmbH, Darmstadt (DE)

(21) Appl. No.: 18/862,026

(22) PCT Filed: Apr. 28, 2023
(86) PCT No.: PCT/EP2023/061237

§ 371 Date: Oct. 31, 2024

(30) Foreign Application Priority Data
May 6, 2022 (EP) 22171960.2

(51) Int. Cl. C08L 33/12; C08K 11/00

(52) U.S. Cl. CPC C08L 33/12; C08K 11/00

(57) ABSTRACT

A crosslinker mixture for reactive resins contains a first di(meth)acrylate diester and a second di(meth)acrylate diester. A reactive resin contains the crosslinker mixture and a 2K (two-component) system contains the reactive resin and a curing agent component. The reactive resin and/or the 2K system find application in floor coatings, as chemical anchors, cable encapsulation compounds and/or road markings.

### FIELD OF THE INVENTION

The present invention relates to a crosslinker mixture for reactive resins. The crosslinker mixture contains a first di(meth)acrylate diester and a second di(meth)acrylate diester. The invention further relates to a reactive resin containing the crosslinker mixture of the invention, and to a 2K (two-component) system comprising the reactive resin and a curing agent component. The invention likewise relates to the use of the reactive resin and/or the 2K system, for example for floor coatings and/or road markings.

### PRIOR ART

The use of crosslinkers in reactive resins is known from the prior art.

For example, EP 2 054 453 B1 describes a (meth)acrylate resin that may contain a crosslinker alongside various (meth)acrylate monomers and polymers. However, the document does not describe mixtures of crosslinkers.

EP 3 929 245 A1 describes a (meth)acrylate-based 2K reactive resin that contains monomers and optionally a crosslinker. This document does not describe mixtures of crosslinkers either.

WO 2020/035561 describes the preparation of a di(meth)acrylate diester by reaction of a (meth)acrylic anhydride with an epoxide in the presence of a catalyst and a chromium-containing cocatalyst. This document does not describe any mixture of crosslinkers, nor use thereof in a reactive resin.

The crosslinkers described in the prior art are already suitable as crosslinkers for reactive resins. However, the preparation of the crosslinkers described in the prior art is frequently inconvenient and costly, and so the crosslinkers themselves are also expensive.

### OBJECT

There is therefore a need for alternative crosslinkers for use in reactive resins and for reactive resins that contain these crosslinkers, and 2K systems comprising the reactive resins. These alternative crosslinkers are to be producible less expensively than the crosslinkers described in the prior art, and cured reactive resins produced therefrom are to have at least comparable mechanical properties to those described in the prior art.

### ACHIEVEMENT OF OBJECT

This object is achieved by a crosslinker mixture for reactive resins, where this crosslinker mixture contains the following components (A) and (B):
(A) at least one first di(meth)acrylate diester of the general formula (I)

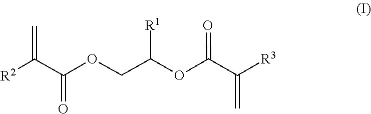

in which
R¹ is H or CH₃,
R² is H or CH₃, and
R³ is H or CH₃;
(B) at least one second di(meth)acrylate diester of the general formula (II)

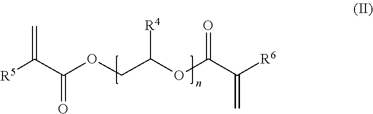

in which
R⁴ is H or CH₃,
R⁵ is H or CH₃,
R⁶ is H or CH₃, and
n is 2 or 3.

In addition, this object is achieved by a reactive resin containing the following components:
0.1% to 30% by weight of the crosslinker mixture as claimed in any of claims 1 to 8,
20% to 80% by weight of a (meth)acrylate monomer,
0% to 40% by weight of prepolymers,
either 0.1% to 10% by weight of an initiator or 0.1% to 5% by weight of an accelerator, based in each case on the total weight of the reactive resin.

In addition, this object is achieved by a 2K system comprising the reactive resin of the invention as a first component and a curing agent component as a second component.

The present invention further provides for the use of the reactive resin of the invention or of the 2K system of the invention for floor coatings, chemical anchors, cable encapsulation compounds and/or road markings.

It has surprisingly been found that the crosslinker mixture of the invention can be used in reactive resins. Reactive resins containing the crosslinker mixture of the invention have similarly good mechanical properties after curing to reactive resins containing the crosslinkers described in the prior art. In particular, the elongation at break and tensile strength thereof are comparable. At the same time, the crosslinker mixture of the invention is more easily and inexpensively producible than crosslinkers described in the prior art. This makes the reactive resins of the invention more economically viable.

A reactive resin containing the crosslinker mixture of the invention additionally has good pot life and curing time.

It has additionally been found that, surprisingly, for the crosslinker mixture of the invention, a smaller difference in density between monomer and polymer is found than for crosslinkers described in the prior art, for example ethylene glycol dimethacrylate or butane-1,4-diol dimethacrylate.

The invention is elucidated in detail hereinafter.

The crosslinker mixture of the invention contains components (A) and (B).

For example, the crosslinker mixture contains in the range from 50% to 90% by weight of component (A), preferably in the range from 60% to 80% by weight, based in each case on the total weight of the crosslinker mixture.

The crosslinker mixture contains, for example, in the range from 10% to 50% by weight of component (B), preferably in the range from 20% to 40% by weight, based in each case on the total weight of the crosslinker mixture.

Preference is therefore also given to a crosslinker mixture containing
50% to 90% by weight of component (A) and
10% to 50% by weight of component (B),
based in each case on the total weight of the crosslinker mixture.

The percentages by weight of components (A) and (B) in the crosslinker mixture preferably add up to 100% by weight. It is therefore preferable that the crosslinker mixture consists essentially of components (A) and (B).

It will be apparent that the percentages by weight of components (A) and (B) relate to the percentages by weight before the crosslinker mixture has reacted with itself or in a reactive resin. It will be clear to the person skilled in the art that the composition of the crosslinker mixture may change as a result of reaction with itself or in a reactive resin.

Component (A) is at least one first di(meth)acrylate diester of the general formula (I)

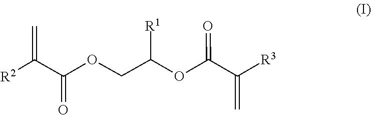

in which
R¹ is H or CH₃,
R² is H or CH₃, and
R³ is H or CH₃.

The term “di(meth)acrylate diester” in the context of the present invention means both dimethacrylate diester and diacrylate diester. If, for example, R² and R³ in formula (I) are H, the first di(meth)acrylate diester is a first diacrylate diester. If, for example, R² and R³ in formula (I) are CH₃, the first di(meth)acrylate diester is a first dimethacrylate diester.

Component (A) is at least one first di(meth)acrylate diester of the general formula (I). The expression “at least one first di(meth)acrylate diester” in the context of the present invention means either exactly one first di(meth)acrylate diester or a mixture of two or more first di(meth)acrylate diesters. Component (A) is preferably a mixture of two or more first di(meth)acrylate diesters.

When R¹ in the general formula (I) is H, the first di(meth)acrylate diester is ethylene glycol di(meth)acrylate. Ethylene glycol di(meth)acrylate is also referred to as ethane-1,2-diol di(meth)acrylate.

When R¹ in the general formula (I) is CH₃, the first di(meth)acrylate diester is propylene glycol di(meth)acrylate. Propylene glycol di(meth)acrylate is also referred to as propane-1,2-diol di(meth)acrylate.

As detailed above, component (A) is preferably a mixture of two or more first di(meth)acrylate diesters. Therefore, component (A) preferably comprises ethylene glycol di(meth)acrylate and propylene glycol di(meth)acrylate.

Preference is therefore also given to a crosslinker mixture in which component (A) comprises ethylene glycol di(meth)acrylate and propylene glycol di(meth)acrylate.

For example, component (A) comprises in the range from 30% to 80% by weight of ethylene glycol di(meth)acrylate, preferably in the range from 50% to 70% by weight, based in each case on the total weight of component (A).

For example, component (A) comprises in the range from 20% to 70% by weight of propylene glycol di(meth)acrylate, preferably in the range from 30% to 50% by weight, based in each case on the total weight of component (A).

Preference is therefore also given to a crosslinker mixture in which component (A) comprises
30% to 80% by weight of ethylene glycol di(meth)acrylate and
20% to 70% by weight of propylene glycol di(meth)acrylate,
based in each case on the total weight of component (A).

The sum total of the percentages by weight of the ethylene glycol di(meth)acrylate and of the propylene glycol di(meth)acrylate in component (A) is preferably 100% by weight. Component (A) more preferably consists of ethylene glycol di(meth)acrylate and propylene glycol di(meth)acrylate.

R² and R³ in formula (I) may be the same or different. If R² and R³ in formula (I) are the same, component (A) is at least one first symmetric di(meth)acrylate diester. If R² and R³ in formula (I) are different, component (A) is at least one first asymmetric di(meth)acrylate diester.

Component (B) is at least one second di(meth)acrylate diester of the general formula (II)

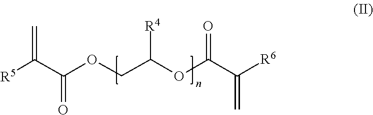

in which
R⁴ is H or CH₃,
R⁵ is H or CH₃,
R⁶ is H or CH₃, and
n is 2 or 3.

Component (B) is at least one second di(meth)acrylate diester of the general formula (II). The expression “at least one second di(meth)acrylate diester” in the context of the present invention means either exactly one second di(meth)acrylate diester or a mixture of two or more second di(meth)acrylate diesters. Component (B) is preferably a mixture of two or more second di(meth)acrylate diesters.

When R⁴ in formula (II) is H, the second di(meth)acrylate diester is typically diethylene glycol di(meth)acrylate and/or triethylene glycol di(meth)acrylate. When R⁴ in formula (II) is CH₃, the second di(meth)acrylate diester is typically dipropylene glycol di(meth)acrylate and/or tripropylene glycol di(meth)acrylate. When R⁴ in formula (II) is CH₃, in the context of the present invention, formula (II) and the terms “dipropylene glycol di(meth)acrylate” and “tripropylene glycol di(meth)acrylate” also encompass the corresponding isomers.

It will be apparent that, when n in formula (II) is 2, component (B) typically comprises diethylene glycol di(meth)acrylate and/or dipropylene glycol di(meth)acrylate. When n in formula (II) is 3, component (B) typically comprises triethylene glycol di(meth)acrylate and/or tripropylene glycol di(meth)acrylate.

R⁵ and R⁶ in formula (II) may be the same or different. If R⁵ and R⁶ in formula (II) are the same, component (B) is at least one second symmetric di(meth)acrylate diester. If R⁵ and R⁶ in formula (II) are different, component (B) is at least one second asymmetric di(meth)acrylate diester.

As detailed above, component (B) is preferably a mixture of two or more second di(meth)acrylate diesters. Therefore, component (B) preferably comprises diethylene glycol di(meth)acrylate and dipropylene glycol di(meth)acrylate.

Preference is therefore also given to a crosslinker mixture in which component (B) comprises diethylene glycol di(meth)acrylate and dipropylene glycol di(meth)acrylate.

Component (B) comprises, for example, 50% to 90% by weight, preferably in the range from 60% to 80% by weight, of diethylene glycol di(meth)acrylate, based in each case on the total weight of component (B).

Component (B) comprises, for example, 10% to 50% by weight, preferably in the range from 20% to 40% by weight, of dipropylene glycol di(meth)acrylate, based in each case on the total weight of component (B).

Preference is therefore also given to a crosslinker mixture in which component (B) comprises
50% to 90% by weight of diethylene glycol di(meth)acrylate and
10% to 50% by weight of dipropylene glycol di(meth)acrylate,
based in each case on the total weight of component (B).

In one embodiment of the present invention, the percentages by weight of diethylene glycol di(meth)acrylate and dipropylene glycol di(meth)acrylate in component (B) add up to 100% by weight. In this embodiment, component (B) consists of diethylene glycol di(meth)acrylate and dipropylene glycol di(meth)acrylate.

It is additionally possible that component (B) comprises further components. For example, component (B) comprises diethylene glycol di(meth)acrylate, triethylene glycol di(meth)acrylate, dipropylene glycol di(meth)acrylate and tripropylene glycol di(meth)acrylate.

Preference is therefore also given to a crosslinker mixture in which the crosslinker mixture contains the following components: ethylene glycol di(meth)acrylate, diethylene glycol di(meth)acrylate, triethylene glycol di(meth)acrylate, propylene glycol di(meth)acrylate, dipropylene glycol di(meth)acrylate and tripropylene glycol di(meth)acrylate.

The crosslinker mixture therefore contains preferably 25% to 50% by weight of ethylene glycol di(meth)acrylate,
10% to 35% by weight of diethylene glycol di(meth)acrylate,
0% to 2% by weight of triethylene glycol di(meth)acrylate,
20% to 35% by weight of propylene glycol di(meth)acrylate,
2% to 15% by weight of dipropylene glycol di(meth)acrylate and
0% to 2% by weight of tripropylene glycol di(meth)acrylate,
based in each case on the total weight of the crosslinker mixture.

Preference is therefore also given to a crosslinker mixture containing
25% to 50% by weight of ethylene glycol di(meth)acrylate,
10% to 35% by weight of diethylene glycol di(meth)acrylate,
0% to 2% by weight of triethylene glycol di(meth)acrylate,
20% to 35% by weight of propylene glycol di(meth)acrylate,
2% to 15% by weight of dipropylene glycol di(meth)acrylate and
0% to 2% by weight of tripropylene glycol di(meth)acrylate,
based in each case on the total weight of the crosslinker mixture.

The crosslinker mixture may additionally contain further components. In particular, the crosslinker mixture may contain in the range from 0.1% to 5% by weight of hydroxyalkyl (meth)acrylate, based on the total weight of the crosslinker mixture. The hydroxyalkyl (meth)acrylate may originate, for example, from the preparation of the crosslinker mixture. Hydroxyalkyl (meth)acrylates that originate from the preparation of the crosslinker mixture are, for example, the first hydroxyalkyl (meth)acrylate of the general formula (III) which is described further down and/or the second hydroxyalkyl (meth)acrylate of the general formula (IV) which is described further down.

The crosslinker mixture of the invention can be prepared by methods known to the person skilled in the art. For example, the individual components of the crosslinker mixture are prepared separately by esterification of (meth)acrylic acid with glycol and/or propylene glycol and then mixed together.

The crosslinker mixture is preferably prepared by a process comprising the following steps a) to d):
a) reacting (meth)acrylic acid with at least one epoxide selected from the group consisting of ethylene oxide and propylene oxide in the presence of a first catalyst to obtain a hydroxyalkyl (meth)acrylate mixture, where the hydroxyalkyl (meth)acrylate mixture contains the following components (C) and (D) and the first catalyst:
   (C) at least one first hydroxyalkyl (meth)acrylate of the general formula (III)

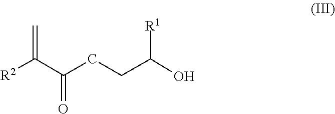

in which
R¹ is H or CH₃, and
R² is H or CH₃;
(D) at least one second hydroxyalkyl (meth)acrylate of the general formula (IV)

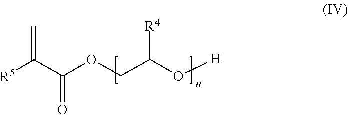

in which
R⁴ is H or CH₃,
R⁵ is H or CH₃, and
n is 2 or 3;
b) distilling the hydroxyalkyl (meth)acrylate mixture obtained in step a) to obtain a first top stream containing component (C), and a first bottom stream containing component (D) and residues of component (C) and the first catalyst,
c) reacting the first bottom stream obtained in step b) with (meth)acrylic acid and/or a C₁-C₄-alkyl (meth)acrylate in the presence of a second catalyst to obtain a mixture containing the crosslinker mixture and the first catalyst and the second catalyst,
d) distilling the mixture obtained in step c) to obtain a second top stream containing the crosslinker mixture, and a second bottom stream containing the first catalyst and the second catalyst.

The first catalyst in step a) is preferably selected from the group consisting of metal salts and organic compounds, each of metals selected from the group consisting of chromium and iron, and mixtures thereof. Such first catalysts are known per se.

The second catalyst in step c) is preferably selected from the group consisting of Brønsted acids and metal salts and organic compounds, each of metals selected from the group consisting of tin, titanium, zirconium, alkali metals and alkaline earth metals, and mixtures thereof. Such second catalysts are known per se.

The process comprising steps a) to d) for production of the crosslinker mixture is particularly advantageous since the distillation residue (the first bottom stream) which is obtained in the preparation of hydroxyalkyl (meth)acrylates can be subjected to further use. Purely thermal disposal of the distillation residue can thus be avoided.

The crosslinker mixture of the invention can be used as crosslinker. For example, the crosslinker mixture may be used as crosslinker in a reactive resin.

The present invention therefore also provides a reactive resin containing the following components
0.1% to 30% by weight of the crosslinker mixture of the invention,
20% to 80% by weight of a (meth)acrylate monomer,
0% to 40% by weight of prepolymers,
either 0.1% to 10% by weight of an initiator or 0.1% to 5% by weight of an accelerator, based in each case on the total weight of the reactive resin.

The crosslinker mixture present in the reactive resin is correspondingly subject to the observations and preferences described above for the crosslinker mixture of the invention.

The reactive resin contains a (meth)acrylate monomer. In the context of the present invention, “a (meth)acrylate monomer” means both exactly one (meth)acrylate monomer and a mixture of two or more different (meth)acrylate monomers.

“(Meth)acrylate monomers” in the context of the present invention mean acrylate monomers, methacrylate monomers and monomers copolymerizable therewith, for example 1-alkenes and styrene. In addition, the term “(meth)acrylate monomers” also includes (meth)acrylic acid.

The (meth)acrylate monomer is therefore preferably selected from the group consisting of alkyl (meth)acrylates, (meth)acrylic acid, 1-alkenes, styrene and mixtures thereof.

If the (meth)acrylate monomer comprises a monomer copolymerizable with acrylate monomers or methacrylate monomers, it is preferable that the (meth)acrylate monomer then comprises a mixture of the copolymerizable monomer and an acrylate monomer or methacrylate monomer.

Preference is therefore also given to a reactive resin in which the (meth)acrylate monomer is selected from the group consisting of alkyl (meth)acrylates, (meth)acrylic acid, 1-alkenes, styrene and mixtures thereof.

“Alkyl (meth)acrylates” in the context of the present invention mean both alkyl acrylates and alkyl methacrylates. Preference is given to C₁-C₁₈-alkyl (meth)acrylates. “C₁-C₁₈-Alkyl (meth)acrylates” mean alkyl esters of (meth)acrylic acid that have 1 to 18 carbon atoms in the alkyl radical. The alkyl radical may be linear, cyclic and/or branched. In addition, it may include aromatic radicals. For example, alkyl (meth)acrylates of the invention are selected from the group consisting of methyl (meth)acrylate, ethyl (meth)acrylate, propyl (meth)acrylate, n-butyl (meth)acrylate, isobutyl (meth)acrylate, 2-ethylhexyl (meth)acrylate, isopentyl (meth)acrylate, stearyl (meth)acrylate, benzyl (meth)acrylate and lauryl (meth)acrylate.

The term “(meth)acrylic acid” in the context of the present invention encompasses both acrylic acid and methacrylic acid.

1-Alkenes capable of copolymerization with methacrylate monomers and/or acrylate monomers are known as such and are, for example, 1-hexene, 1-heptene, vinylcyclohexane, 3,3-dimethyl-1-propene, 3-methyl-1-diisobutylene and 4-methylpent-1-ene.

The term “styrene” in the context of the present invention means not only styrene as such but also substituted styrenes, for example α-methylstyrene, α-ethylstyrene, vinyltoluene, p-methylstyrene, monochlorostyrenes, dichlorostyrenes and tribromostyrenes.

According to the invention, the reactive resin contains 20% to 80% by weight, preferably 45% to 75% by weight, of the (meth)acrylate monomer, based in each case on the total weight of the reactive resin.

The term “prepolymers” means either exactly one prepolymer or a mixture of two or more prepolymers.

A “prepolymer” in the context of the present invention has a weight-average molecular weight in the range from 1000 g/mol to 80 000 g/mol, preferably in the range from 25 000 g/mol to 70 000 g/mol, determined by GPC with PMMA as standard.

Suitable prepolymers are selected, for example, from the group consisting of polyalkyl(meth)acrylates, polyesters, polyurethane(meth)acrylates and mixtures thereof.

Preference is therefore also given to a reactive resin in which the prepolymers are selected from the group consisting of polyalkyl(meth)acrylates, polyesters, polyurethane(meth)acrylates and mixtures thereof.

“Polyalkyl (meth)acrylates” in the context of the present invention mean polymers and copolymers of alkyl (meth)acrylates as described further up.

Suitable polyesters are known as such and are preferably obtainable via polycondensation or ring-opening polymerization.

“Polyurethane (meth)acrylates” in the context of the present invention mean (meth)acrylates joined to one another via urethane groups. They are obtainable by reaction of hydroxyalkyl (meth)acrylates with polyisocyanates and polyoxyalkylenes having at least two hydroxy functionalities. Instead of hydroxyalkyl (meth)acrylates, it is also possible to use esters of (meth)acrylic acid with oxiranes, for example ethylene oxide or propylene oxide, or corresponding oligooxiranes or polyoxiranes. Suitable polyurethane (meth)acrylates are known per se.

The reactive resin contains 0% to 40% by weight, preferably 5% to 30% by weight, of prepolymers, based on the total weight of the reactive resin.

The reactive resin of the invention contains either an initiator or an accelerator. In the context of the present invention, what is meant by “either an initiator or an accelerator” is that the reactive resin preferably contains only the initiator and no accelerator or the reactive resin contains only an accelerator and no initiator.

The reactive resin preferably contains only the accelerator. It is thus preferable that the reactive resin does not contain any initiator.

What is meant by “an initiator” in the context of the present invention is either exactly one initiator or a mixture of two or more different initiators. Exactly one initiator is preferred in accordance with the invention.

Suitable initiators are all compounds known to the person skilled in the art that are capable of initiating free-radical polymerization of the (meth)acrylate monomer. For example, the at least one initiator is selected from the group consisting of peroxides, azo compounds and persulfates. The initiator is preferably selected from the group consisting of peroxides and azo compounds.

Preference is therefore also given to a reactive resin in which the initiator is selected from the group consisting of peroxides and azo compounds.

Suitable peroxides are selected, for example, from the group consisting of hydrogen peroxide, dibenzoyl peroxide, dicyclohexyl peroxodicarbonate, dilauryl peroxide, methyl ethyl ketone peroxide, acetylacetone peroxide, di-tert-butyl peroxide, tert-butyl hydroperoxide, cumene hydroperoxide, tert-butyl peroctanoate, tert-butyl per-2-ethylhexanoate, tert-butyl perneodecanoate, tert-amyl perpivalate, tert-butyl perpivalate, tert-butyl perbenzoate, di(tert-amyl) peroxide (DTAP), tert-butyl peroxy (2-ethylhexyl) carbonate (TBPEHC), dicumyl peroxide, diisopropyl peroxydicarbonate and bis(4-t-butylcyclohexyl) peroxydicarbonate.

Suitable azo compounds are selected, for example, from the group consisting of 2,2-azobisiso-2,4-dimethylvaleronitrile, 2,2-azobisisobutyronitrile, 2,2′-azobis(2-amidinopropane) dihydrochloride, 2-(carbamoylazo) isobutyronitrile and 4,4′-azobis(cyanovaleric acid).

Suitable persulfates are selected, for example, from the group consisting of lithium peroxodisulfate, sodium peroxodisulfate, potassium peroxodisulfate and ammonium peroxodisulfate.

For example, the reactive resin contains 0.1% to 10% by weight, preferably 1% to 5% by weight, of the initiator, based on the total weight of the reactive resin.

As set out above, the reactive resin, in a preferred embodiment of the present invention, does not contain any initiator.

What is meant by “an accelerator” in the context of the present invention is either exactly one accelerator or a mixture of two or more different accelerators. Exactly one accelerator is preferred.

Accelerators used may be compounds known to the person skilled in the art that accelerate the curing of the reactive resin. Suitable accelerators are, for example, symmetric tertiary aromatic amines, asymmetric tertiary aromatic amines and/or phosphites.

Suitable symmetric tertiary aromatic amines are selected, for example, from the group consisting of N,N-dimethyl-p-toluidine, N,N-bis(2-hydroxyethyl)-p-toluidine and N,N-bis(2-hydroxypropyl)-p-toluidine.

Suitable asymmetric amines are selected, for example, from the group consisting of N-methyl-N-(hydroxyethyl)-p-toluidine, N-methyl-N-(hydroxyethyl)-m-toluidine, N-methyl-N-(hydroxypropyl)-p-toluidine, an N-methyl-N-(hydroxyethyl) xylidine, an N-methyl-N-(hydroxypropyl) xylidine, N-methyl-N-(hydroxyethyl) aniline and N-methyl-N-(hydroxypropyl) aniline.

Suitable phosphites are selected, for example, from the group consisting of tri-2-ethylhexyl phosphite, tri-2-ethylhexyl trithiophosphite, triisooctyl phosphite, triisooctyl trithiophosphite, tridecyl phosphite, tridecyl trithiophosphite, trilauryl phosphite, trilauryl trithiophosphite, trioctadecyl phosphite, trioctadecyl trithiophosphite, phenyl didecyl phosphite, phenyl didecyl trithiophosphite, phenyl dilauryl phosphite, phenyl distearyl phosphite, phenyl distearyl trithiophosphites, diphenyl decyl phosphite, diphenyl lauryl phosphite, diphenyl stearyl phosphite, diphenyl stearyl trithiophosphite, tri-para-cresyl phosphite, tri-meta-cresyl phosphite, tri-ortho-cresyl phosphites, tri-para-cresyl dithiophosphite, tri-para-octylphenyl trithiophosphite, tri-ortho-octylphenyl phosphite, tris(dipropylene glycol) phosphite, triethoxyethyl phosphite, tributoxyethyl phosphite, tritetrahydrofurfuryl phosphite, tritetrahydrofurfuryl trithiophosphite, triphenylethyl phosphite, S-phenyl dilauryl monothiophosphite, S-phenyl didecyl monothiophosphite, SS-diphenyl lauryl dithiophosphite, SS-diphenyl decyl dithiophosphite, tri-ortho-naphthyl phosphite, SS-diphenyl decyl dithiophosphite, phenyl dilauryl trithiophosphite, tridodecylphenyl phosphite, trichlorophenyl phosphite, diphenyl lauryl trithiophosphite, S-lauryl diphenyl monothiophosphite, tri-p-methoxyphenyl phosphite, SO-diphenyl S-lauryl dithiophosphite, tri-o-methoxyphenyl dithiophosphite, SS-dilauryl phenyl dithiophosphite and SO-dilauryl S-phenyl dithiophosphite.

For example, the reactive resin contains 0.1% to 5% by weight, preferably 0.5% to 3% by weight, of the accelerator, based in each case on the total weight of the reactive resin.

The reactive resin of the invention can be used, for example, in a 2K system.

The present invention therefore also relates to a 2K system comprising the reactive resin of the invention as a first component and a curing agent component as the second component.

The first component, the reactive resin of the invention, is subject to the above-described observations and preferences.

The second component, the curing agent component, when mixed with the first component, the reactive resin, initiates and/or accelerates the polymerization of at least the (meth)acrylate monomer present in the reactive resin.

The curing agent component therefore contains either the accelerator or the initiator. Typically, the curing agent component contains the accelerator when the reactive resin contains the initiator. The curing agent component contains the initiator when the reactive resin contains the accelerator.

The initiator present in the curing agent component is correspondingly subject to the observations and preferences described above for the initiator present in the reactive resin.

For example, the curing agent component contains 0.1% to 10% by weight, preferably 1% to 5% by weight, of the initiator, based on the total weight of the reactive resin present in the 2K system.

The accelerator present in the curing agent component is correspondingly subject to the observations and preferences described above for the accelerator present in the reactive resin.

For example, the curing agent component contains 0.1% to 5% by weight, preferably 0.5% to 3% by weight, of the accelerator, based in each case on the total weight of the reactive resin present in the 2K system.

The curing agent component may consist either of the initiator or the accelerator. In that case, the reactive resin preferably does not contain the component of which the curing agent component consists.

It is additionally possible that the curing agent component, as well as either the initiator or the accelerator, contains further components, for example the dyes and/or fillers and/or auxiliaries and additives specified further down. It is preferable in accordance with the invention that the curing agent component is essentially free of (meth)acrylate monomers.

For example, the 2K system comprises 50% to 99.9% by weight of the first component and 0.1% to 50% by weight of the second component.

Preferably in accordance with the invention, it is the first component in the 2K system, the reactive resin, that contains the accelerator. In that case, the second component, the curing agent component, contains the initiator. In this embodiment, the reactive resin preferably does not contain any initiator. In that case, the curing agent component preferably does not contain any accelerator.

Preference is therefore also given to a 2K system in which the reactive resin contains the accelerator and the curing agent component contains the initiator.

The 2K system may also contain dyes and/or fillers. For example, the 2K system contains in the range from 0% to 90% by weight, preferably in the range from 5% to 50% by weight, of dyes and/or fillers, based on the total weight of the 2K system.

Particularly suitable dyes are, for example, white, red, blue, green and/or yellow inorganic pigments. Particular preference is given to white inorganic pigments such as titanium dioxide.

Fillers are in particular mineral fillers. Mineral fillers are preferably selected from the group consisting of calcium carbonate, barium sulfate, quartz, ground quartz, precipitated silicas, fumed silicas, corundums, glass beads and cristobalites.

The 2K system may additionally contain auxiliaries and additives. For example, the 2K system contains in the range from 0.1% to 5% by weight of auxiliaries and additives, based on the total weight of the 2K system. Auxiliaries and additives for 2K systems are known as such and are selected, for example, from the group consisting of chain transfer agents, plasticizers, paraffins, stabilizers, inhibitors, waxes and oils.

Paraffins are added, for example, in order to prevent inhibition of polymerization by oxygen from the air. It is possible to use for this purpose two or more paraffins having different melting points in different concentrations.

Chain transfer agents used may be any of the compounds known from free-radical polymerization. Preference is given to using mercaptans such as n-dodecyl mercaptan, but also polyfunctional mercapto compounds, such as pentaerythritol tetrathioglycolate.

Plasticizers used are preferably esters, polyols, oils, low molecular weight polyethers or phthalates.

Useful stabilizers are in particular UV stabilizers. The UV stabilizers are preferably selected from the group consisting of benzophenone derivatives, benzotriazole derivatives, thioxanthonate derivatives, piperidinol carboxylic ester derivatives and cinnamic ester derivatives.

From the group of inhibitors, preference is given to using substituted phenols, hydroquinone derivatives, phosphines and phosphites.

For use of the 2K system, the first component, the reactive resin, and the second component, the curing agent component, are mixed with one another. After the first component has been mixed with the second component, the 2K system typically has only a limited open time of, for example, 2 to 40 minutes that remains for use, for example for application, pouring, coating or filling. Thereafter, the 2K system typically cures. The term “open time” in accordance with the invention thus means the period between the mixing of the first component with the second component and the curing of the 2K system. The open time thus corresponds to the period over which the 2K system is processible. The open time is also referred to as pot life.

The 2K system of the invention and/or the reactive resin of the invention can be used, for example, for floor coatings, chemical anchors, cable encapsulation compounds and/or road markings.

The invention is elucidated in detail hereinafter by examples, without restriction thereto.

### EXAMPLES

Curing Experiments with Different Crosslinkers

A reactive resin containing the components specified in table 1 and 5% by weight of the crosslinker specified in table 2, for curing, are admixed with 2% by weight of a curing agent component (50% dibenzoyl peroxide (BPO) in dicyclohexyl phthalate), stirred for two minutes and then applied to a metal surface in a layer thickness of about 2 mm or poured into the test cups described below.

TABLE 1

| Component | % by wt. |
|---|---|
| Methyl methacrylate | 60.54 |
| Polymerization inhibitor | 0.05 |
| Ethylhexyl acrylate | 10 |
| Paraffin | 0.4 |
| Polymethylmethacrylate, PMMA, suspension | 22.0 |
| polymer, CAS No. 9011-14-7 | |
| Stabilizer | 0.31 |
| Additive | 0.7 |
| Diisopropoxy-para-toluidine | 1.0 |

TABLE 2

| Crosslinker designation | Crosslinker name |
|---|---|
| 1,4-BDDMA | Butane-1,4-diol dimethacrylate |
| IGDMA (isoglycol dimethacrylate) | Inventive crosslinker mixture of the |
| | composition in table 3 |
| EGDMA | Ethylene glycol dimethacrylate |

TABLE 3

| Composition of the crosslinker mixture of the invention | [GC area %] |
|---|---|
| Ethylene glycol dimethacrylate | 32.82 |
| Diethylene glycol dimethacrylate | 26.93 |
| Triethylene glycol dimethacrylate | 0.52 |
| 1,2-Propylene glycol dimethacrylate | 28.11 |
| Dipropylene glycol dimethacrylate, sum of isomers | 8.69 |
| Tripropylene glycol dimethacrylate, sum of isomers | 0.13 |
| Further constituents | 2.80 |

Pot life (PL) is determined by measuring the time taken for the resultant 2K system to independently warm up from room temperature (20-22° C.) to 32° C. after the curing agent component has been stirred in. For this purpose, 20 g of the 2K system as described above is produced in a plastic vessel.

The temperature maxima (Tmax) were determined by measuring the time taken for 20 g of the resultant 2K system in a PE beaker having a diameter of 45 mm to reach the temperature maximum during curing.

The time taken for the surface test (S-test) to have been passed is determined as the time after which the surface of the layer poured out in a thickness of 2 mm has been cured and is non-tacky. The time is started with stirring of the curing agent component into the reactive resin; it is stopped as soon as the poured layer no longer sticks to a gloved finger on contact.

Mechanical properties (tensile modulus, tensile strength, breaking stress, elongation at break) were determined at 23° C. to DIN EN ISO 527:2019 by casting the corresponding reactive resin in the form of test specimens. The results are shown in table 4.

TABLE 4

| | Comparative | | Comparative |
|---|---|---|---|
| Example | Example 1 | Example 2 | Example 3 |
| Crosslinker | 1,4-BDDMA | IGDMA | EGDMA |
| PL [min] | 16 | 15 | 15 |
| Tmax [min] | 24 | 24 | 24 |
| maxT [° C.] | 157 | 176 | 164 |
| S-test [min] | 32 | 32 | 33 |
| Tensile modulus (Eₜ) [MPa] | 2740 | 2750 | 2700 |
| Tensile strength (σM) [MPa] | 62 | 57.6 | 46.2 |
| Breaking stress (σB) [MPa] | 61.1 | 57.3 | 46.1 |
| Elongation at break at σM [%] | 2.7 | 2.5 | 1.8 |
| Elongation at break at σB [%] | 2.9 | 2.5 | 1.8 |
| Nominal elongation at σM [%] | 2.7 | 2.4 | 1.8 |
| Nominal elongation at break | 2.7 | 2.4 | 1.8 |
| at σB [%] | | | |

The crosslinker mixture of the invention gives mechanical properties comparable to the mechanical properties of 1,4-BDDMA. Compared to EGDMA, improved mechanical properties were actually achieved. In particular, tensile modulus was found to be particularly high in the comparison of the crosslinking experiments.

The use of the crosslinker mixture of the invention not only achieves comparable mechanical properties; the crosslinker mixture of the invention is also less expensive in terms of production than, for example, 1,4-BDDMA and EGDMA.

1. A crosslinker mixture for reactive resins, the crosslinker mixture comprising:
(A) at least one first di(meth)acrylate diester of the general formula (I) 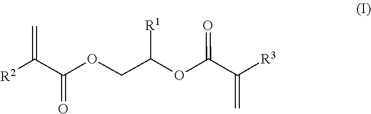
in which
R¹ is H or CH₃,
R² is H or CH₃, and
R³ is H or CH₃;
(B) at least one second di(meth)acrylate diester of the general formula (II) 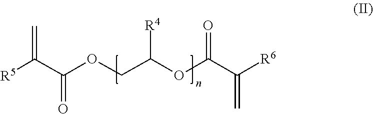
in which
R⁴ is H or CH₃,
R⁵ is H or CH₃,
R⁶ is H or CH₃, and
n is 2 or 3.

2. The crosslinker mixture as claimed in claim 1, wherein the crosslinker mixture comprises
50% to 90% by weight of component (A) and
10% to 50% by weight of component (B),
based in each case on a total weight of the crosslinker mixture.

3. The crosslinker mixture as claimed in claim 1, wherein component (A) comprises ethylene glycol di(meth)acrylate and propylene glycol di(meth)acrylate.

4. The crosslinker mixture as claimed in claim 3, wherein component (A) comprises
30% to 80% by weight of ethylene glycol di(meth)acrylate and
20% to 70% by weight of propylene glycol di(meth)acrylate,
based in each case on a total weight of component (A).

5. The crosslinker mixture as claimed in claim 1, wherein component (B) comprises diethylene glycol di(meth)acrylate and dipropylene glycol di(meth)acrylate.

6. The crosslinker mixture as claimed in claim 5, wherein component (B) comprises
50% to 90% by weight of diethylene glycol di(meth)acrylate and
10% to 50% by weight of dipropylene glycol di(meth)acrylate,
based in each case on a total weight of component (B).

7. The crosslinker mixture as claimed in claim 1, wherein the crosslinker mixture comprises ethylene glycol di(meth)acrylate, diethylene glycol di(meth)acrylate, triethylene glycol di(meth)acrylate, propylene glycol di(meth)acrylate, dipropylene glycol di(meth)acrylate and tripropylene glycol di(meth)acrylate.

8. The crosslinker mixture as claimed in claim 7, wherein the crosslinker mixture comprises
25% to 50% by weight of ethylene glycol di(meth)acrylate,
10% to 35% by weight of diethylene glycol di(meth)acrylate,
0% to 2% by weight of triethylene glycol di(meth)acrylate,
20% to 35% by weight of propylene glycol di(meth)acrylate,
2% to 15% by weight of dipropylene glycol di(meth)acrylate and
0% to 2% by weight of tripropylene glycol di(meth)acrylate,
based in each case on a total weight of the crosslinker mixture.

9. A reactive resin, comprising:
0.1% to 30% by weight of the crosslinker mixture as claimed in claim 1,
20% to 80% by weight of a (meth)acrylate monomer,
0% to 40% by weight of one or more prepolymers,
either 0.1% to 10% by weight of an initiator or 0.1% to 5% by weight of an accelerator, based in each case on a total weight of the reactive resin.

10. The reactive resin as claimed in claim 9, wherein the one or more prepolymers are selected from the group consisting of polyalkyl (meth)acrylates, polyesters, polyurethane (meth)acrylates and mixtures thereof.

11. The reactive resin as claimed in claim 9, wherein the (meth)acrylate monomer is selected from the group consisting of alkyl (meth)acrylates, (meth)acrylic acid, 1-alkenes, styrene and mixtures thereof.

12. A 2K system, comprising:
the reactive resin as claimed in claim 9 as a first component, and
a curing agent component as a second component.

13. The 2K system as claimed in claim 12, wherein the reactive resin contains the accelerator and wherein the curing agent component contains an initiator.

14. Floor coatings, chemical anchors, cable encapsulation compounds and/or road markings comprising the reactive resin as claimed in claim 9.

15. Floor coatings, chemical anchors, cable encapsulation compounds and/or road markings comprising the 2K system as claimed in claim 12.
